(19) United States
(12) Patent Application Publication
(10) Pub. No.: US 2024/0228296 A1
(43) Pub. Date: Jul. 11, 2024

(54) Fabrication method and application of cobalt and nitrogen co-doped three-dimensional structured carbon matrix

(71) Applicant: SINOSTEEL NANJING ADVANCED MATERIALS RESEARCH INSTITUTE CO., LTD., Nanjing (CN)

(72) Inventors: Xiang DENG, Nanjing (CN); Xiaodong PEI, Nanjing (CN); Yanhua LUO, Nanjing (CN)

(21) Appl. No.: 17/769,275

(22) PCT Filed: Oct. 27, 2021
(86) PCT No.: PCT/CN2021/126545

§ 371 Date: Mar. 11, 2024

(30) Foreign Application Priority Data
Jun. 9, 2021 (CN) 202110641082.8

(51) Int. Cl. C01B 32/194; H01M 4/86; H01M 4/90; H01M 8/1004

(52) U.S. Cl. CPC C01B 32/194; H01M 4/9083; H01M 8/1004; C01B 2202/22; C01B 2204/22; C01P 2002/52; C01P 2002/72; C01P 2004/03; C01P 2004/13; C01P 2004/24; C01P 2006/40; H01M 2004/8689

(57) ABSTRACT

The present invention relates to fabrication method and application of cobalt and nitrogen co-doped three-dimensional (3D) structured carbon matrix, more particularly, to the 3D structured carbon matrix is crosslinked by carbon nanotubes and graphene nanosheets. The fabrication method is: the cobalt salt solution is firstly prepared and totally mixed with the 2-methylimidazole organic ligand. After filtration, the carbon precursor is obtained. The carbon precursor is fully washed, dried and grounded with the inorganic salt powder containing template and pore-forming agents. Finally, the mixture is calcinated at elevated temperature. The product is acid-washed and dried to obtain the 3D structured carbon matrix product. The as-prepared 3D structured carbon matrix product can be a promising noble metal-free catalyst as the cathode for the polymer electrolyte membrane fuel cell.

### TECHNICAL FIELD

The present invention relates to a Cobalt and nitrogen co-doped three-dimensional structured carbon matrix, and fabrication method and application therefor. This synthesis method of functional carbon matrix holds great promise for the development of porous carbon materials and their related devices.

### BACKGROUND ART

Carbonaceous materials are abundant in the resource and widely participated in various chemical reactions. Nowadays, the development of novel carbon materials becomes a hot spot for the researchers. There are different kinds of nanostructured carbon such as the zero dimensional carbon sphere or carbon quantum dots (CQDs), one dimensional carbon nanotubes (CNTs), two dimensional carbon nanosheets or graphene, as well as the three dimensional porous carbon matrix. These nanostructured carbon materials have high surface areas, porosity and conductivity. In addition, due to the excellent mechanical strength and chemical durability, these novel carbon materials can also be applied into various fields including high-strength structural components, chemical engineering and conductive additives. Recently, the researchers have discovered that the heteroatom-doping such as nonmetallic elements nitrogen (N), phosphorus (P), boron (B), as well as the transition metal elements cobalt (Co), iron (Fe), nickel (Ni), copper (Cu) on the carbon matrix can boost the catalytic activity of carbon ring structure to different kinds of small molecule activation reactions. Therefore, the heteroatom doped carbon composites are introduced to be a high-performance cathode material for the proton exchange membrane fuel cell (PEMFC) with the target of further reducing the Pt loading.

However, the sole doping strategy seems to be still not enough for the practical device-level application for these carbon materials. Therefore, the co-doping strategy to introduce two or more heteroatoms like Co, Fe, N, etc. is proposed to make the further optimization. In addition, the nanostructure-engineering is also applied to construct three-dimensional porous structure and facilitate the mass-transfer processes in the microcosmic interfaces.

### DISCLOSURE

### Technical Problem

The existing doped carbon composite materials still have a relatively low catalytic activity on the oxygen reduction reaction (ORR) as the cathode for proton exchange membrane fuel cells (PEMFCs). In addition, the mechanical strength and porosity of the carbon nanostructure is still not sufficient, which will cause the pulverization failure of the catalyst layer as well as the high mass transfer resistance. Both of these disadvantages limit the practical application of these novel carbon materials. In order to solve these technical problems, our invention proposes the synthesis method of a Co and N co-doped three-dimensional structured carbon matrix, which has a unique porous structure and surface area. This as-prepared carbon material has well-developed catalytic interfaces and an excellent ORR activity. In addition, the mechanical strength of the microstructure for this carbon material is adequate to prevent the pulverization failure during the reaction processes. Furthermore, the synthesis method for this novel carbon material is facile, safe and environmental-friendly. It is highly suitable for the industrial production and the products have great promise to be the electrodes for the PEMFC applications.

### SUMMARY

The invention aims to provide a method for preparing a Co and N co-doped three-dimensional structured carbon matrix, the method comprises the following steps:

A method for preparing cobalt and nitrogen co-doped three-dimensional structured carbon matrix crosslinked by carbon nanotubes and graphene nanosheets, wherein comprises the following steps: the cobalt salt solution is firstly prepared and totally mixed with the 2-methylimidazole organic ligand. After filtration, the carbon precursor is obtained. The carbon precursor is fully washed, dried, and then grounded with the inorganic salt powder containing templating agent and pore-forming agents. After that, the mixture is calcinated at elevated temperature. The product is acid-washed to remove the remained template and pore-forming agents inside the carbon complex and dried to obtain the 3D structured carbon matrix product.

The specific synthesis method is described as follows:

(1) The preparation of metal salt solution: the metal salt solution contains the solvated cobalt ions.

(2) The formation of the carbon precursor: the 2-methylimidazole organic ligand is added into the metal salt solution in step (1) under continuous stirring. After the reaction is completed, the sediment is filtrated to obtain the carbon precursor powder.

(3) High-temperature calcination (activation): the precursor powder in step (2) is fully washed, dried and grounded with the inorganic salt powder containing template and pore-forming agents. After that, the mixture is calcinated at elevated temperature. The product is acid-washed to remove the remained template and pore-forming agents inside the carbon complex and dried to obtain the 3D structured carbon matrix product.

Preferably, the metal salt solution contains cobalt and zinc ions. The soluble cobalt salt could be cobalt nitrate hexahydrate, cobalt sulfate, cobalt chloride, etc. The soluble zinc salt could be zinc nitrate hexahydrate, zinc sulfate, zinc chloride, etc. The solvent for the metal salt solution could be water, methanol, ethanol, ethylene glycol, isopropyl alcohol, etc.

Preferably, the concentration of the metal salt solution is in the range of 0.05-0.3 mol/L, and the metal salt solution contains cobalt (Co) and zinc (Zn) salts, the mole ratio of Zn and Co is 1:(0.1-0.6).

Preferably, the reaction time of the metal salt solution and 2-methylimidazole is 0.5-5 h with the reaction temperature of 20-90° C., and the mole ratio between the metal salt solution and 2-methylimidazole organic ligand solution is 1:(2-5).

Preferably, the high-temperature calcination is in the range of 700-1050° ° C. with a reaction time of 1-6 h under a vacuum or inert gas atmosphere during the step (3). The inert gas atmosphere could be N2, Ar and etc.

Preferably, the inorganic salt powder is a composite activator composed of a template agent and a pore-forming agent mixed in a specific ratio. The mass ratio between the template and pore-forming agents is 1:(0.1˜1), the template agent is a chloride, carbonate, or hydroxide of sodium or potassium, and the pore-forming agent is zinc chloride. The addition of the mixture of template and pore forming agents into the organic precursor will play an important role in the pore-forming process during the carbon formation by organic precursors. On the one hand, the template can occupy a large number of spaces inside the carbon, leading to both mesopores and macropores in the carbon matrix by acid wash after carbonization; On the other hand, pore forming agent can react with carbonaceous organic precursors at high temperature to promote the formation of carbon ring defect sites, resulting in the generation of numerous micropores. The three-dimensional carbon material with a large number of micropores, mesopores and macropores can greatly improve the internal reaction area of the catalyst during the reaction process, so as to enhance the catalytic performance.

Preferably, the mass ratio of organic salt powder to carbon precursor powder is 1:(0.1-0.5).

Preferably, the as-mentioned acid wash process of the product in step (3) is also aiming to remove the template agent inside the carbon matrix. The template agent occupies a large number of spaces on a microscopic level. The acid wash process removes the occupied template agent to produce the macropores and mesopores, which also promotes the generation of two-dimensional (2D) graphene and the interplay with cobalt catalytically generated one-dimensional (1D) carbon nanotubes. This unique combination of 2D and 1D structured carbon morphology is the most typical feature of the product in the present invention.

The specified acids used in the acid wash could be sulfuric acid, hydrochloric acid, nitric acid or other inorganic acid aqueous solutions with a concentration ≤3 mol/L. During the acid wash, the products after the high temperature activation are soaked in the acid solution at 30-80° C. and stirred for 1-10 h. Then, they are fully washed with pure water and dried to be the final products.

The cobalt and nitrogen co-doped three-dimensional structured carbon matrix prepared by the method can be a promising noble metal-free catalyst as the cathode for the polymer electrolyte membrane fuel cell.

### Beneficial Effects

(1) The as-prepared carbon matrix not only has a Co, N co-doped functional surface, but also shows a unique microstructure as shown in FIGS. 1 and 2. The microstructure of this carbon material is composed by both the carbon nanotubes and graphene nanosheets. The carbon nanotubes and graphene nanosheets are crosslinked and supported with each other from the microcosmic level, which effectively improves the surface area, porosity, and the mechanical strength of this porous carbon matrix. At the same time, the microstructure of carbon material has enough strength to deal with the micro stress generated during the reaction processes and prevent the pulverization failure, which has great promise in the application as the cathode of the proton exchange membrane fuel cells.

(2) Our invention provides an innovative inorganic-salts-assisted calcination method to synthesize the Co, N co-doped carbon with a unique porous microstructure. The inorganic salts act as both the template and pore-forming agents during the high-temperature carbonization process, which can produce the unique three-dimensional carbon structure crosslinked by carbon nanotubes and graphene nanosheets. In the existing technology, if the doping elements contains only cobalt, carbon materials will only form carbon nanotube structures (such as the report in China's patent No. 201810662634.1). Interestingly, in our patent, the invention reports the mixture of the inorganic salt powders could act as both the template and pore-forming agent. The template agent such as sodium chloride and potassium chloride are face-centered cubic structure. Under the high temperature activation process, the template agent creates and occupies the pores by melting and distributing into the carbon precursor. After the acid wash to remove the template, the macroporous and mesoporous structure are generated, forming two-dimensional graphene nanosheets. In other words, in our invention part of the carbon nanotubes structure is transformed into two-dimensional graphene nanosheets. In addition, one-dimensional carbon nanotubes and two-dimensional graphene nanosheets become the interwoven microstructure. At the same time, the pore-forming agent zinc chloride can active the carbon precursors at high temperature, promoting the formation of the carbon ring defect sites. Thus, the hierarchical microporous, mesoporous and macroporous structure of the produced carbon material has a high specific surface area, porosity and enhanced mechanical strength. This carbon material shows a good catalytic interface effect. In addition, this nanostructure also provides high mechanical strength by interwoven and composite of carbon nanotubes and graphene sheets.

(3) The synthesis method provided by this invention is highly recommended for the large-scale industrial production. The carbon precursors are mixed with the inorganic-salts by simple mechanical grinding, calcination and wash to obtain the targeted production, which is time-saving, low-cost and environmental-friendly.

(4) The as-prepared Co, N co-doped three-dimensional structured carbon matrix can act as a high-performance noble-metal free electrode for PEMFCs.

### BRIEF DESCRIPTION OF DRAWINGS

FIG. 1 is a global overview of the Scanning Electron Micrograph (SEM) of the sample #1-1 prepared in inventive example 1 (IE1).

FIG. 2 is a local enlargement of the Scanning Electron Micrograph (SEM) of the sample #1-1 prepared in inventive example 2 (IE2).

FIG. 3 is a local enlargement of the Scanning Electron Micrograph (SEM) of the sample #1-2 prepared in comparative example 1 (CE1).

FIG. 4 is the electrocatalytic performance comparison of the samples #1-1 and #1-2 from IE1 and its comparison (CE1).

FIG. 5 is the X-ray diffraction results of the samples #1-1, #1-2 and #2-1 from IE1, CE1 and IE2.

FIG. 6 is a global overview of the Scanning Electron Micrograph (SEM) of the sample #3-1 prepared in inventive example 3 (IE3).

### DESCRIPTION OF EMBODIMENTS

### Embodiment 1

A typical preparation method of Co, N co-doped three-dimensional structured carbon matrix is characterized by the following steps:

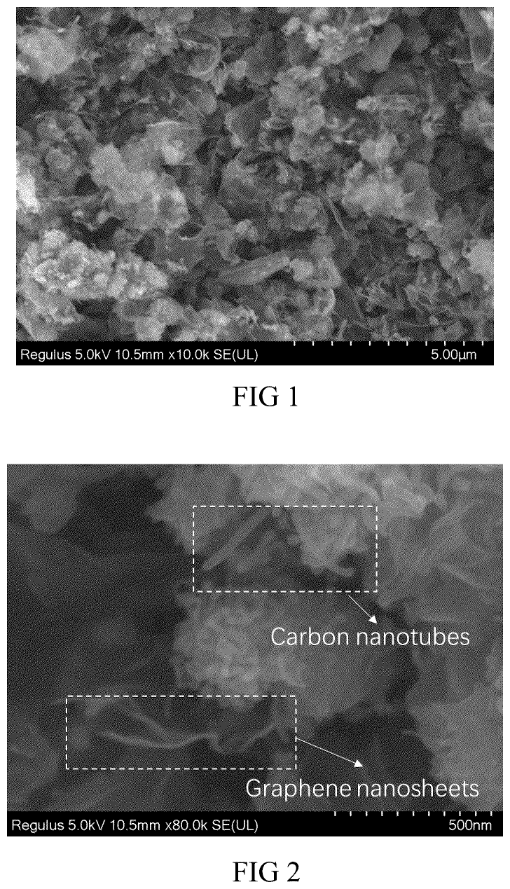

Solution A: 9 mmol zinc nitrate hexahydrate and 5 mmol cobalt nitrate hexahydrate are dissolved into 50 ml methanol. Solution B: 39 mmol 2-methylimidazole is dissolved into 50 ml methanol. Solution A and B are mixed under continuous stirring. This mixed solution is kept stirring for 5 h under a constant temperature of 25° C. After reaction, the carbon precursors are filtrated from the solution. 0.3 g this carbon precursor is totally mechanical ground with mixed inorganic salts (2.7 g KCl and 0.3 g ZnCl₂). Then, the powder mixture is calcinated for 1 h at 1000° ° C. under a pure nitrogen atmosphere. After the natural cooling, the carbon powder is fully immersed into 1 mol/L H₂SO₄ and stirred for 10 h at 30° C. to completely wash away the remained inorganic salts and other impurities. Finally, the carbon product is rinsed with pure water and dried to be powders. The as-obtained carbon matrix is labeled as #1-1. From the SEM image of FIG. 1, the #1-1 sample exhibits loosely-stacked carbon clusters. The local enlargement image from FIG. 2 also shows that the loosely-stacked carbon clusters are composed of one-dimensional carbon nanotubes and two-dimensional graphene nanosheets which are crosslinked with each other. The BET surface area of #1-1 is measured to be 725 m²/g with a porosity of 0.92 cm³/g. The #1-1 is also assembled to be the MEA for H₂—O₂ PEMFC with the active area of 25 cm². The single cell test results reveal that the as-prepared noble-metal free cathode gives a power output of 673 mW cm⁻² at an operation voltage of 0.6V.

### Comparative Example 1 (CE1)

The comparative example is mainly characterized in that no inorganic salts are added to assist the high-temperature carbonization. The specific method includes the following steps:

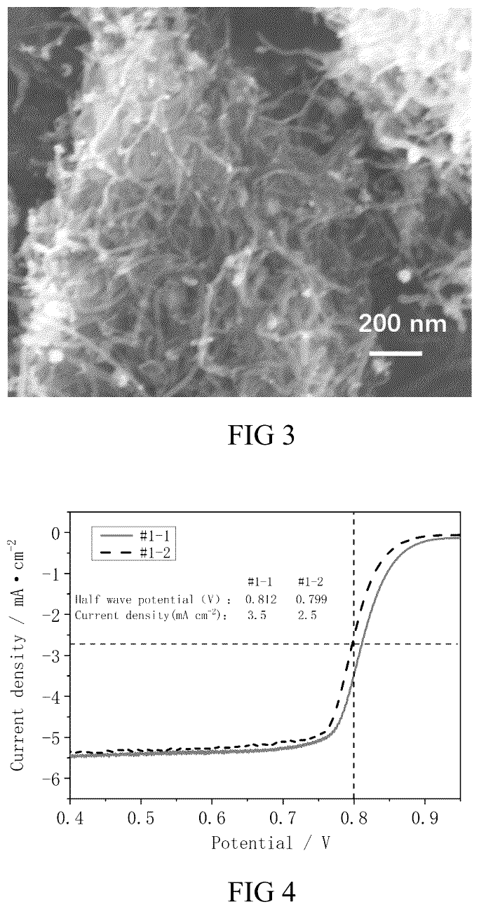

Solution A: 9 mmol zinc nitrate hexahydrate and 5 mmol cobalt nitrate hexahydrate are dissolved into 50 ml methanol. Solution B: 39 mmol 2-methylimidazole is dissolved into 50 ml methanol. Solution A and B are mixed under continuous stirring. This mixed solution is kept stirring for 5 h under a constant temperature of 25° C. After reaction, the carbon precursors are filtrated from the solution. Then, the carbon precursors are calcinated for 1 h at 1000° C. under a pure nitrogen atmosphere. After the natural cooling, the carbon powder is fully immersed into 1 mol/L H₂SO₄ and stirred for 10 h at 30° C. to completely wash away the remained impurities. Finally, the carbon product is rinsed with pure water and dried to be powders. The as-obtained carbon matrix is labeled as #1-2. From the local enlargement SEM image of FIG. 3, the #1-2 prepared without the inorganic salts is bulk-like blocks wrapped by one-dimensional carbon nanotubes. No two-dimensional graphene nanosheets are observed. The BET surface area of #1-2 is measured to be 430 m²/g with a porosity of 0.31 cm³/g. The #1-2 is also assembled to be the MEA for H₂—O₂ PEMFC with the active area of 25 cm². The single cell test results reveal that the as-prepared noble-metal free cathode gives a power output of only 268 mW cm⁻² at an operation voltage of 0.6V.

The sample #1-1 and #1-2 are also evaluated by the rotating disk electrode (RDE) method with the electrochemical results showing in FIG. 4. The sample #1-1 prepared by the inorganic salt assisted method has a much improved ORR activity compared to sample #1-2. As the result, the half-wave potential of ORR for #1-1 increase by 13 mV, and the output current density is 1.5 times higher at 0.8V under the similar operation conditions.

### Embodiment 2

Another preparation method of Co, N co-doped three-dimensional structured carbon matrix is characterized by the following steps:

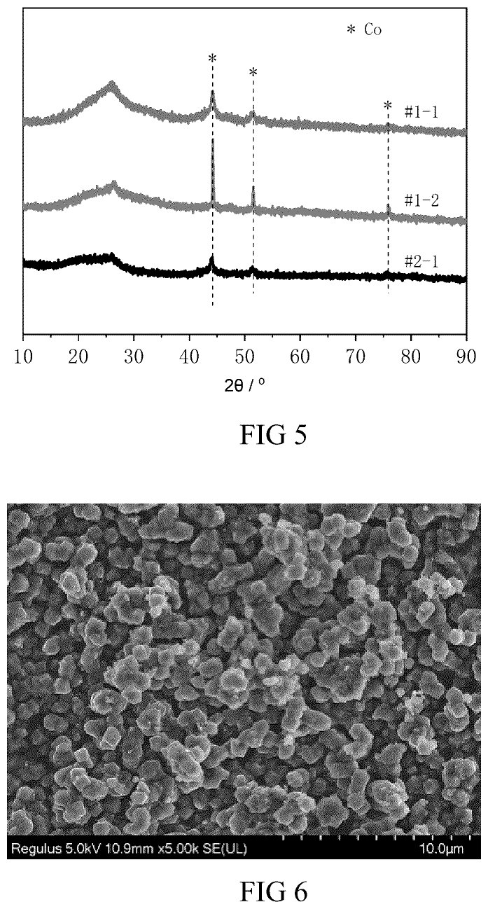

Solution A: 9 mmol zinc nitrate hexahydrate and 2 mmol cobalt nitrate hexahydrate are dissolved into 150 ml ethylene glycol. Solution B: 30 mmol 2-methylimidazole is dissolved into 50 ml ethylene glycol. Solution A and B are mixed under continuous stirring. This mixed solution is kept stirring for 1 h under a constant temperature of 90° C. After reaction, the carbon precursors are filtrated from the solution. 0.3 g this carbon precursor is totally mechanical ground with mixed inorganic salts (0.6 g KCl and 0.4 g ZnCl₂). Then, the carbon precursors are calcinated for 6 h at 900° C. under a pure nitrogen atmosphere. After the natural cooling, the carbon powder is fully immersed into 3 mol/L HCl and stirred for 1 h at 80° C. to completely wash away the remained inorganic salts and other impurities. Finally, the carbon product is rinsed with pure water and dried to be powders. The as-obtained carbon matrix is labeled as #2-1. The BET surface area of #2-1 is measured to be 690 m²/g with a porosity of 0.77 cm³/g. The XRD results from FIG. 5 show that #1-1, #1-2 and #2-1 all exhibit the pure phase of Co—C composites. The existing form of cobalt element in carbon matrix is cobalt metal nanoparticles. From the XRD peak density of Co, the sample #1-2 which has no inorganic salts during the preparation shows serious agglomeration after the high-temperature calcination treatment, leading to a decreased catalytic activity. These results also prove that the inorganic salts assisted synthesis method can stabilize the porous structure of carbon matrix during/after the high-temperature carbonization process. Therefore, the Co element can form a stable and uniform dispersion on the carbon matrix, contributing to the overall performance of the catalyst. The single cell test result reveal that the as-prepared noble-metal free cathode (#2-1) gives a power output of 427 mW cm⁻² at an operation voltage of 0.6V.

### Embodiment 3

Another preparation method of Co, N co-doped three-dimensional structured carbon matrix is characterized by the following steps:

Solution A: 9 mmol zinc nitrate hexahydrate and 1 mmol cobalt nitrate hexahydrate are dissolved into 50 ml distilled water. Solution B: 50 mmol 2-methylimidazole is dissolved into 50 ml distilled water. Solution A and B are mixed under continuous stirring. This mixed solution is kept stirring for 0.5 h under a constant temperature of 60° C. After reaction, the carbon precursors are filtrated from the solution. 0.3 g this carbon precursor is totally mechanical ground with mixed inorganic salts (2.0 g KCl and 0.5 g ZnCl₂). Then, the carbon precursors are calcinated for 2 h at 700° ° C. under a pure nitrogen atmosphere. After the natural cooling, the carbon powder is fully immersed into 1 mol/L HCl and stirred for 3 h at 60° C. to completely wash away the remained inorganic salts and other impurities. Finally, the carbon product is rinsed with pure water and dried to be powders. The as-obtained carbon matrix is labeled as #3-1. The BET surface area of #3-1 is measured to be 833 m²/g with a porosity of 0.87 cm³/g. The microstructure of #3-1 is shown in FIG. 6. It can be observed that comparatively large carbon blocks with a particle size of ˜1 um are generated with small amount of carbon nanotubes and graphene nanosheets, indicating the calcination temperature of 700° C. may be too low for the generation of carbon nanotube and graphene nanosheet structures.

### Embodiment 4

Another preparation method of Co, N co-doped three-dimensional structured carbon matrix is characterized by the following steps:

Solution A: 9 mmol zinc nitrate hexahydrate and 1 mmol cobalt nitrate hexahydrate are dissolved into 50 ml distilled water. Solution B: 50 mmol 2-methylimidazole is dissolved into 50 ml distilled water. Solution A and B are mixed under continuous stirring. This mixed solution is kept stirring for 2.0 h under a constant temperature of 60° C. After reaction, the carbon precursors are filtrated from the solution. 2.0 g this carbon precursor is totally mechanical ground with mixed inorganic salts (2.0 g KCl and 2.0 g ZnCl₂). Then, the carbon precursors are calcinated for 2 h at 700° C. under a pure nitrogen atmosphere. After the natural cooling, the carbon powder is fully immersed into 1 mol/L HCl and stirred for 3 h at 60° C. to completely wash away the remained inorganic salts and other impurities. Finally, the carbon product is rinsed with pure water and dried to be powders. The as-obtained carbon matrix is labeled as #4-1. The BET surface area of #4-1 is measured to be 570 m²/g with a porosity of 0.47 cm³/g.

1.-10. (canceled)

11. A method for preparing cobalt and nitrogen co-doped three-dimensional structured carbon matrix crosslinked by carbon nanotubes and graphene nanosheets, wherein comprises the following steps: The cobalt salt solution is firstly prepared and totally mixed with the 2-methylimidazole organic ligand, After filtration, the carbon precursor is obtained; The carbon precursor is fully washed, dried, and then grounded with the inorganic salt powder containing template and pore-forming agents; After that, the mixture is calcinated at elevated temperature, and finally the product is acid-washed and dried to obtain the 3D structured carbon matrix product.

12. The method according to claim 11, wherein the mass ratio between the template and pore-forming agents is 1:(0.1˜1), the template agent is a chloride, carbonate, or hydroxide of sodium or potassium, and the pore-forming agent is zinc chloride.

13. The method according to claim 11, wherein the mass ratio of organic salt powder to carbon precursor powder is 1:(0.1-0.5).

14. The method according to claim 11, wherein the reaction time of the metal salt solution and 2-methylimidazole is 0.5-5 h with the reaction temperature of 20-90° C., and the high-temperature calcination is in the range of 700-1050° ° C. with a reaction time of 1-6 h under a vacuum or inert gas atmosphere.

15. The method according to claim 11, wherein the metal salt solution contains cobalt (Co) and zinc (Zn) salts.

16. The method according to claim 15, wherein the mole ratio of Zn and Co is 1:(0.1-0.6).

17. The method according to claim 11, wherein The mole ratio between the metal salt solution and 2-methylimidazole organic ligand solution is 1:(2-5).

18. The method according to claim 12, wherein The mole ratio between the metal salt solution and 2-methylimidazole organic ligand solution is 1:(2-5).

19. The method according to claim 13, wherein The mole ratio between the metal salt solution and 2-methylimidazole organic ligand solution is 1:(2-5).

20. The method according to claim 14, wherein The mole ratio between the metal salt solution and 2-methylimidazole organic ligand solution is 1:(2-5).

21. The method according to claim 15, wherein The mole ratio between the metal salt solution and 2-methylimidazole organic ligand solution is 1:(2-5).

22. The method according to claim 16, wherein The mole ratio between the metal salt solution and 2-methylimidazole organic ligand solution is 1:(2-5).

23. A noble metal-free catalyst, wherein the noble metal-free catalyst is prepared by the cobalt and nitrogen co-doped three-dimensional structured carbon matrix prepared by the method according to claim 11.

24. A application of the cobalt and nitrogen co-doped three-dimensional structured carbon matrix prepared by the method according to claim 11 in the preparation of electrode materials for proton exchange membrane fuel cells.
